(19) United States
(12) Patent Application Publication
(10) Pub. No.: US 2009/0289394 A1
(43) Pub. Date: Nov. 26, 2009

(54) METHOD FOR MANUFACTURING SHOE SOLE USING NATURAL LATEX

(76) Inventor: GEUN CHOUN LIM, SEOUL (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/469,646

(22) Filed: May 20, 2009

(30) Foreign Application Priority Data
May 20, 2008 (KR) 10-2008-0046520

(51) Int. Cl. B29C 67/24

(52) U.S. Cl. 264/330

(57) ABSTRACT

The present invention relates to a method for manufacturing a shoe sole using a natural latex in which a shoe sole is made of a liquid or solid natural latex, so a walking pressure is uniformly distributed during walking, and an impact is absorbed and released for a comfortable walking, and a slip does not occur with the help of a reliable non-slip function, and feet health can be enhanced along with a good ventilation and anti-microbial effect by providing a number of air cells, and an outer appearance looks good since a sole is made of a transparent material, and an environment-friendly product can be manufactured.

### DETAILED DESCRIPTION OF THE INVENTION

1. Technical Field

The present invention relates to a method for manufacturing a shoe sole using a natural latex, and in particular to a method for manufacturing a shoe sole made of a liquid or solid natural latex, so a walking pressure is uniformly distributed during walking, and an impact is absorbed and released for a comfortable walking, and a slip does not occur with the help of a reliable non-slip function, and feet health can be enhanced along with a good ventilation and anti-microbial effect by providing a number of air cells, and an outer appearance looks good since a sole is made of a transparent material, and an environment-friendly product can be manufactured.

2. Background Art

Generally, latex is a sticky liquid which can be obtained after scratching a skin of a hevea brasilliensis with knife and is used as a raw material of various products after processing it with chemicals.

### DESCRIPTIONS OF THE INVENTION

### [Problems to be Overcome]

A conventional sole is generally made of a copolymer of synthetic rubber, polyurethane, ethylene, and vinyl acetate, and a polyurethane sole has good elastic, forming and recovery performance, but has bad ventilation and water absorption performance, and an ethylene and vinyl acetate copolymer has bad elastic, forming, recovery, ventilation and water absorption performances.

In addition, in case of sole made of synthetic rubber, the function of the sole is enhanced by adding various compounds. For example, carbon is added so as to enhance the hardness.

The sole added with the carbon has poor transparency and black color. But since photolysis is strong, it is not decomposed when discarding for thereby polluting environment.

Accordingly, it is an object of the present invention to provide a method for manufacturing a shoe sole using a natural latex in which first a shoe sole is made of a liquid or solid natural latex, so a walking pressure is uniformly distributed during walking, and an impact is absorbed and released for a comfortable walking, and second a slip does not occur with the help of a reliable non-slip function, and third feet health can be enhanced along with a good ventilation and anti-microbial effect by providing a number of air cells, and fourth an outer appearance looks good since a sole is made of a transparent material, and an environment-friendly product can be manufactured.

### [Means For Overcoming the Problems]

To achieve the above objects, there is provided a method for manufacturing a shoe sole using a natural latex which comprises a step in which sulphur of vulcanization agent and ZnO are ground in a ball mill along with water and is mixed with a liquid natural latex and is agitated; a step in which a vulcanization accelerator is added to the agitating mixture liquid; a step in which an emulsifier is emulsified in water using plasticizer, and is agitated and mixed with the mixed liquid of the above step; a step in which the mixture liquid is substantially agitated and is processed for 24 hours at a room temperature; a step in which the processed mixture liquid is inputted into a sole mold and is heated for 15 to 20 minutes at 150° C. and is hardened; and a step in which the hardened material is naturally cooled for thereby molding a sole. In addition, sulphur of 0.8 weight %, ZnO of 0.5 weight % are mixed with respect to 100 weight % of the liquid natural latex, and 0.4 weight % of NaDBC of dithio carbamate vulcalvanization accelerator is added.

In another embodiment of the present invention, there is provided a method for manufacturing a shoe sole using a natural latex which comprises a step in which a solid mixture of sulphur, stearic acid and ZnO from which moisture is evaporated is mixed with a solid natural latex and is agitated; a step in which a vulcanization accelerator is added to the agitating mixture liquid and is substantially agitated; a step in which the mixture liquid is processed for 24 hours at a room temperature; a step in which the processed mixture liquid is inputted into a sole mold and is sealed and is heated for 15 to 20 minutes at 150° C. and is hardened; and a step in which the hardened mixture is naturally cooled for thereby molding a sole. 1.7 weight % of sulphur, 2 weight % of stearic acid and 3 weight % of ZnO are mixed with respect to 100 weight % of a solid natural latex, and 1.5 weight % of MBT and 0.2 weight % of TMTD thium vulcanization accelerator are added.

### [Effects]

In the present invention, a shoes sole is made of a liquid or solid natural latex, so a walking pressure is uniformly distributed during walking, and an impact is absorbed and released for a comfortable walking, and a slip does not occur with the help of a reliable non-slip function, and feet health can be enhanced along with a good ventilation and anti-microbial effect by providing a number of air cells, and an environment-friendly product can be manufactured.

In addition, an outer appearance looks good since a sole is made of a transparent material, and an environment-friendly product can be manufactured.

### DETAILED DESCRIPTION FOR CARRYING OUT THE INVENTION

The manufacturing method of the present invention will be described.

First, the method for manufacturing a sole using a liquid natural latex will be described.

Sulphur and ZnO are ground using a ball mill along with water, and the mixture of ground sulphur and ZnO is mixed with a liquid natural latex and is agitated.

Vulcanization accelerator of NaDBC is added to the agitating mixture and is further agitated for 30 minutes.

Plastisizer of NEDCIZER is emulsified in water using emulsifier of Koremul-NP 5 and is agitated with the above mixture and is mixed.

The mixture is substantially agitated and is processed for 24 hours at a room temperature.

The processed mixture is inputted into a sole mold and is sealed and heated for 15 to 20 minutes at 150° C., and is naturally cooled for thereby molding a sole.

In the above process, the sulphur of a vulcanization agent and ZnO of vulcanization accelerator are ground in a ball mill along with water for enhancing elasticity and is mixed with liquid natural latex, and is substantially agitated while adding a small amount of NaDBC.

NaDBC (Na-dibutyl diathiocarbamate: NOCCELER TP) is a dithio carbamate vulcalvanization accelerator, and NEDCIZER-A is a plasticizer of emulsifier manufactured by Hannongwasung Incorporation.

In the above, sulphur of 0.8 weight %, ZnO of 0.5 weight % are mixed with respect to 100 weight % of the liquid natural latex, and 0.4 weight % of NaDBC is added.

Second, the method for manufacturing a sole with a solid natural latex will be described in a state that moisture is evaporated.

Sulphur, stearix acid and ZnO are ground in a ball mill.

The ground mixture is mixed with a solid natural latex and is agitated, and is substantially mixed and agitated while adding vulcanization accelerator of MBT and TMTD to the agitating liquid mixture.

The mixed liquid is processed for 24 hours at a room temperature.

The processed mixture liquid is inputted into a sole mold and is sealed and headed for 15 to 20 minutes at 150° C. and is hardened and is naturally cooled for thereby manufacturing a sole.

In the above, sulphur of vulcanization agent, ZnO and stearic acid are ground in the ball mill, and is mixed with a solid natural latex in a state that moisture is evaporated, and after the mixture, it is substantially agitated while adding a small mount of MBT and TMTD.

The MBT (2-Mercapto benzo thiazole: NOCCELER M) is a thiazole vulcanization agent of vulcanization accelerator, and TMDT) Tetramethylthiuram disulfide: NOCCELER TT) is a thiuram vulcanization agent of a super strong vulcanization accelerator.

In the above, 1.7 weight % of sulphur, 2 weight % of stearic acid and 3 weight % of ZnO are mixed with respect to 100 weight % of a solid natural latex, and 1.5 weight % of MBT and 0.2 weight % of TMTD are added.

In the above, the mold is formed in a structure of which interior is sealed by means a lid.

When the sole molded according to the present invention is adapted to shoes, an impact absorption release and pressure distribution effect is added to a physical performance of a natural latex, and the pressure when a user walks is uniformly distributed, and the impact on the ground is absorbed and released, so a user can more comfortably walk.

Non-slip function is obtained by means of a reliable non-slip effect, and when agitating and foaming a liquid latex or a solid latex, a number of air cells are formed for thereby enhancing ventilation effect, and a user's foot health can be enhanced by means of an anti-microbial function.

In addition, the sole is transparent, so outer appearance looks good, and an environment friendly product can be manufactured. Since a natural latex extracted from a rubber tree is used as a main material, a photolysis is excellent when discarding soles, so the soles can be decomposed by means of light in a natural state.

What is claimed is:

1. A method for manufacturing a shoe sole using a natural latex, comprising:
a step in which sulphur of vulcanization agent and ZnO are ground in a ball mill along with water and is mixed with a liquid natural latex and is agitated;
a step in which a vulcanization accelerator is added to the agitating mixture liquid;
a step in which an emulsifier is emulsified in water using plasticizer, and is agitated and mixed with the mixed liquid of the above step;
a step in which the mixture liquid is substantially agitated and is processed for 24 hours at a room temperature;
a step in which the processed mixture liquid is inputted into a sole mold and is heated for 15 to 20 minutes at 150° C. and is hardened; and
a step in which the hardened material is naturally cooled for thereby molding a sole.

2. A method for manufacturing a shoe sole using a natural latex, comprising:
a step in which a solid mixture of sulphur, stearic acid and ZnO from which moisture is evaporated is mixed with a solid natural latex and is agitated;
a step in which a vulcanization accelerator is added to the agitating mixture liquid and is substantially agitated;
a step in which the mixture liquid is processed for 24 hours at a room temperature;
a step in which the processed mixture liquid is inputted into a sole mold and is sealed and is heated for 15 to 20 minutes at 150° C. and is hardened; and
a step in which the hardened mixture is naturally cooled for thereby molding a sole.
